(19) United States
(12) Patent Application Publication
(10) Pub. No.: US 2017/0114507 A1
(43) Pub. Date: Apr. 27, 2017

(54) SYSTEM FOR SECURING SEMI-RIGID FOAM MEMBERS, AND RELATED DEVICES, COMPONENTS, AND METHODS

(71) Applicant: Nomaco Inc., Zebulon, NC (US)

(72) Inventor: Randal Lee Henderson, Zebulon, NC (US)

(21) Appl. No.: 15/332,582

(22) Filed: Oct. 24, 2016

Related U.S. Application Data
(60) Provisional application No. 62/245,078, filed on Oct. 22, 2015.

(51) Int. Cl. E01C 11/06; E01C 11/04; B28B 23/00; E01C 11/10; B28B 1/14; B28B 11/24

(52) U.S. Cl. CPC E01C 11/06; B28B 1/14; B28B 11/245; B28B 23/00; E01C 11/10; E01C 11/045

(57) ABSTRACT

A system for securing a semi-rigid foam member with respect to a poured curable material structure includes a semi-rigid foam member and a stabilizing bracket. Each stabilizing bracket comprises a body and at least one protrusion extending from a facial surface of the body. Each protrusion is configured to be manually and toollessly inserted into the semi-rigid foam member to secure the body of the respective stabilizing bracket to the semi-rigid foam member. The body of each stabilizing bracket can be secured to a support structure to secure the body and the semi-rigid foam member to a support surface of the support structure, with a base surface of the body and a base surface of the semi-rigid foam member abutting the support surface. The semi-rigid foam member is disposed adjacent to the poured curable material structure during curing.

### PRIORITY APPLICATION

The present application claims priority to U.S. patent application Ser. No. 62/245,078 filed on Oct. 22, 2015 entitled “SYSTEM FOR SECURING SEMI-RIGID FOAM MEMBER, AND RELATED DEVICES, COMPONENTS, AND METHODS,” which is incorporated herein by reference in its entirety.

### BACKGROUND

The disclosure relates generally to a system for securing semi-rigid foam members, and more particularly to securing semi-rigid foam members with respect to a poured curable material structure, which may be used in construction and other applications.

Thermal expansion of structures formed from concrete and other poured courable materials can cause damage to the structure over time, particularly with structures that are exposed to relatively large temperature variations in an outdoor environment. For example, as concrete members expand or contract, cracks may form in members, and gaps may form between adjacent members. If the gaps are too narrow, thermal expansion of the members may cause the members to contact and press against each other, potentially damaging the structure.

To combat this problem, expansion joints may be provided between different concrete members. Conventional expansion joints may be formed from different materials, and are generally flexible and resilient. One common application for expansion joints is between sections of a concrete sidewalk, walkway, driveway, or other relatively flat support structure for pedestrian or vehicular traffic. Prior to pouring the concrete sidewalk, traditional expansion joints are set between concrete forms. The concrete is then poured, and the concrete members set with the expansion joints permanently secured therebetween.

With traditional expansion joints, however, expansion joints may need to be supported with a temporary brace, such as wooden 2×4s, to keep the expansion joints properly positioned and to add rigidity and support against the force of the poured concrete. Without such bracing, the relatively flexible expansion joints may warp or collapse under load from the liquid concrete. However, the wooden 2×4 braces or similar members must then be removed just as the concrete is beginning to set, and the gaps left by the braces must then be quickly backfilled. This creates a time-sensitive bottleneck when pouring concrete structures that use these types of expansion joints. Accordingly, there is a need for an improved process for securing flexible expansion joints with respect to a poured curable material structure during curing.

No admission is made that any reference cited herein constitutes prior art. Applicant expressly reserves the right to challenge the accuracy and pertinency of any cited documents.

### SUMMARY

Embodiments include a system for securing a semi-rigid foam member with respect to a poured curable material structure. The system comprises a semi-rigid foam member and at least one stabilizing bracket. The semi-rigid foam member has a base surface and at least one wall surface for being disposed adjacent a poured curable material structure during curing. For example, without limitation, the semi-rigid foam member may be used as a concrete expansion joint or a concrete form member. Each stabilizing bracket comprises a body having a base surface and a facial surface and at least one protrusion extending from the facial surface. Each protrusion is configured to be manually and toollessly inserted into the semi-rigid foam member to secure the body of the respective stabilizing bracket to the semi-rigid foam member. When the protrusion of a respective stabilizing bracket is inserted into the semi-rigid foam member, the facial surface of the body abuts a wall surface of the semi-rigid foam member, and the base surface of the body is adjacent the base surface of the semi-rigid foam member. The body of each stabilizing bracket can be secured to a support structure to secure the body and the semi-rigid foam member to a support surface of the support structure, with the base surface of the body and the base surface of the semi-rigid foam member abutting the support surface.

With the semi-rigid foam member and each stabilizing bracket secured to the support surface in this manner, the poured curable material can be poured into a volume adjacent the semi-rigid foam member, with the semi-rigid foam member remaining adjacent to the poured curable material structure during curing. One advantage of this arrangement is that the stabilizing brackets can be attached to the semi-rigid foam member quickly and easily, and can be left in place when the poured curable material is poured. In this manner, the time required to prepare and install semi-rigid foam members adjacent a poured curable material structure is significantly reduced, which is particularly important when the curing process is time-sensitive such as with, without limitation, concrete structures.

According to an embodiment, a system for securing a semi-rigid foam member with respect to a poured curable material structure comprises a semi-rigid foam member having a base surface and at least one wall surface is disclosed. The system further comprises at least one stabilizing bracket. Each stabilizing bracket comprises a body comprising a base surface and a facial surface. Each stabilizing bracket further comprises at least one protrusion extending from the facial surface, the at least one protrusion configured to be manually and toollessly inserted into the semi-rigid foam member to secure the body to the semi-rigid foam member, with the facial surface of the body abutting one of the at least one wall surface, and with the second wall surface of the semi-rigid foam member and the base surface of the body adjacent the base surface of the semi-rigid foam member. The body of each stabilizing bracket is configured to be secured to a support structure to secure the body and the semi-rigid foam member to a support surface of the support structure, such that the base surface of the body and the base surface of the semi-rigid foam member abut the support surface, and such that the at least one wall surface of the semi-rigid foam member is configured to be disposed adjacent a poured curable material structure during curing.

According to another embodiment, a stabilizing bracket for securing a semi-rigid foam member with respect to a poured curable material structure is disclosed. The stabilizing bracket comprises a body comprising a base surface and a facial surface. The stabilizing bracket further comprises at least one protrusion extending from the facial surface. The at least one protrusion is configured to be manually and toollessly inserted into a semi-rigid foam member to secure the body to the semi-rigid foam member, with the facial surface of the body abutting one of the at least one wall surface, and with one of the at least one wall surface of the semi-rigid foam member and the base surface of the body adjacent the base surface of the semi-rigid foam member. The body of each stabilizing bracket is configured to be secured to a support structure to secure the body and the semi-rigid foam member to a support surface of the support structure, such that the base surface of the body and the base surface of the semi-rigid foam member abut the support surface, and such that the at least one wall surface of the semi-rigid foam member is configured to be disposed adjacent a poured curable material structure during curing.

According to another embodiment, a method of securing a semi-rigid foam member with respect to a poured curable material structure is disclosed. The method comprises providing a semi-rigid foam member having a base surface and at least one wall surface. The method further comprises manually and toollessly inserting a protrusion of at least one stabilizing bracket into the semi-rigid foam member to secure a body of the stabilizing bracket to the semi-rigid foam member, with a facial surface of the body abutting one of the at least one wall surface, and with one of the at least one wall surface of the semi-rigid foam member and the base surface of the body adjacent the base surface of the semi-rigid foam member. The method further comprises securing the body of each stabilizing bracket to a support structure to secure the body and the semi-rigid foam member to a support surface of the support structure, such that the base surface of the body and the base surface of the semi-rigid foam member abut the support surface, and such that the at least one wall surface of the semi-rigid foam member is configured to be disposed adjacent a poured curable material structure during curing.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings illustrate one or more embodiments, and together with the description serve to explain principles and operation of the various embodiments.

### BRIEF DESCRIPTION OF THE DRAWINGS

FIGS. 1A-1D illustrate a method for assembling and installing a system for securing a semi-rigid foam member against a poured curable material structure, according to an embodiment;

FIGS. 2A-2G illustrate a plurality of views of a stabilizing bracket usable with the semi-rigid foam member of FIGS. 1A-1D and having a flared base for added stability, according to another embodiment;

FIGS. 3A-3C illustrate a method of pouring a curable material into a form, with a pair of systems similar to the system of FIGS. 1A-1D disposed between sections of the curable material structure as expansion joints, according to another embodiment;

FIG. 4A illustrates a method of securing a concrete form during curing of a poured curable material according to the prior art;

FIG. 4B illustrates a method of securing a concrete form during curing of a poured curable material system similar to the system of FIGS. 1A-1D, according to another embodiment;

FIG. 5 illustrates an isometric view of a stabilizing bracket having a pair of differently-sized apertures for accommodating differently sized fasteners therethrough, according to another embodiment;

FIGS. 6A and 6B illustrate top and perspective views of a stabilizing bracket having a pair of barbed protrusions for inhibiting removal of the stabilizing bracket from the semi-rigid foam member, according to another embodiment;

FIGS. 7A and 7B illustrate a method for assembling and installing a system for securing a semi-rigid foam member against a poured curable material structure using a stabilizing bracket similar to the stabilizing bracket of FIGS. 6A and 6B, according to another embodiment;

FIGS. 8A and 8B illustrate top and perspective views of a stabilizing bracket having keyed protrusions configured to be rotated after insertion through the semi-rigid foam member, thereby inhibiting removal of the stabilizing bracket from the semi-rigid foam member, according to another embodiment;

FIGS. 9A-9D illustrate a method for assembling and installing a system for securing a semi-rigid foam member against a poured curable material structure using a stabilizing bracket similar to the stabilizing bracket of FIG. 6, according to another embodiment; and

FIG. 10 is a flowchart of the method of FIGS. 9A-9D, according to an embodiment.

### DETAILED DESCRIPTION

Embodiments include a system for securing a semi-rigid foam member with respect to a poured curable material structure. The system comprises a semi-rigid foam member and at least one stabilizing bracket. The semi-rigid foam member has a base surface and at least one wall surface for being disposed adjacent a poured curable material structure during curing. For example, without limitation, the semi-rigid foam member may be used as a concrete expansion joint or a concrete form member. Each stabilizing bracket comprises a body having a base surface and a facial surface and at least one protrusion extending from the facial surface. Each protrusion is configured to be manually and toollessly inserted into the semi-rigid foam member to secure the body of the respective stabilizing bracket to the semi-rigid foam member. When the protrusion of a respective stabilizing bracket is inserted into the semi-rigid foam member, the facial surface of the body abuts a wall surface of the semi-rigid foam member, and the base surface of the body is adjacent the base surface of the semi-rigid foam member. The body of each stabilizing bracket can be secured to a support structure to secure the body and the semi-rigid foam member to a support surface of the support structure, with the base surface of the body and the base surface of the semi-rigid foam member abutting the support surface.

With the semi-rigid foam member and each stabilizing bracket secured to the support surface in this manner, the poured curable material can be poured into a volume adjacent the semi-rigid foam member, with the semi-rigid foam member remaining adjacent to the poured curable material structure during curing. One advantage of this arrangement is that the stabilizing brackets can be attached to the semi-rigid foam member quickly and easily, and can be left in place when the poured curable material is poured. In this manner, the time required to prepare and install semi-rigid foam members adjacent a poured curable material structure is significantly reduced, which is particularly important when the curing process is time-sensitive such as with, without limitation, concrete structures.

Various embodiments will be further clarified by the following examples.

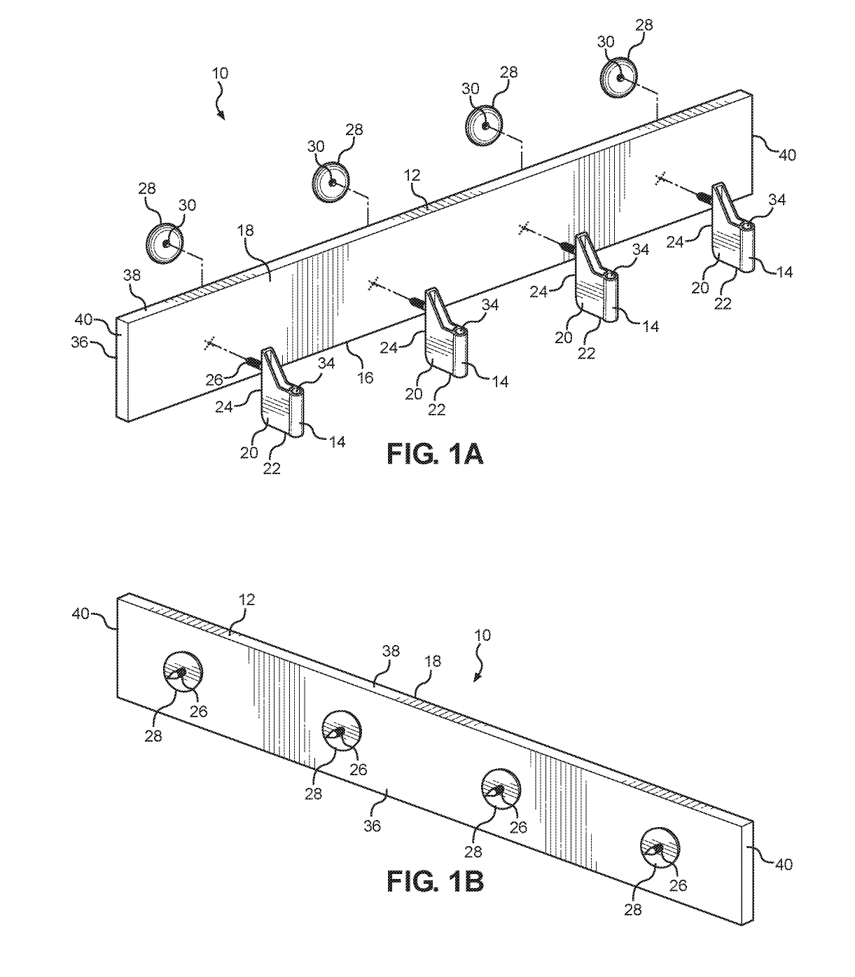

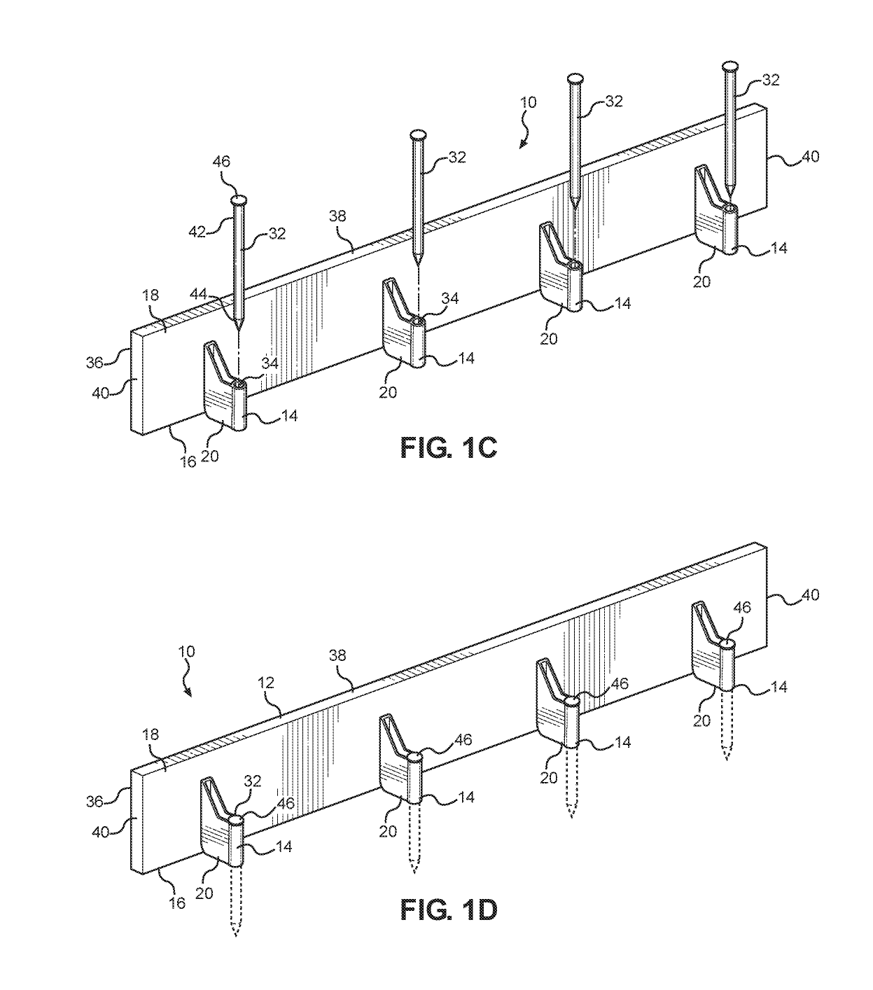

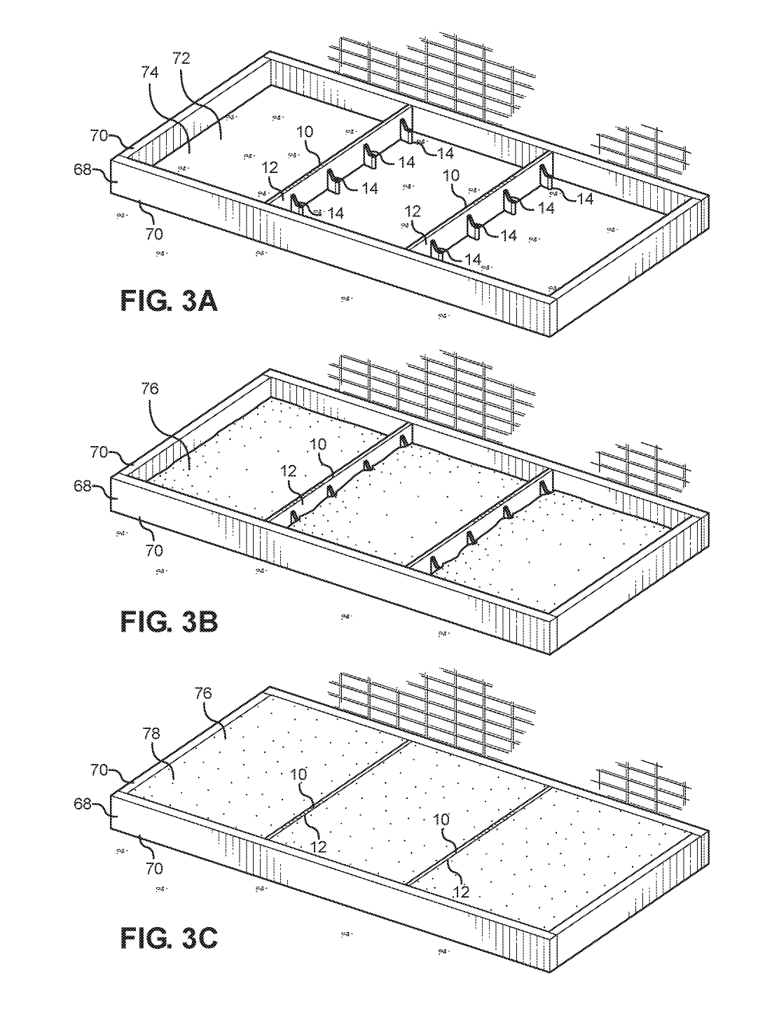

In this regard, FIGS. 1A-1D illustrate a method for assembling and installing a system 10 for securing a semi-rigid foam member 12 against a poured curable material structure, according to an embodiment. The system 10 comprises a semi-rigid foam member 12 and one or more stabilizing brackets 14. The semi-rigid foam member 12 has a base surface 16 and at least one wall surface 18 for being disposed adjacent a poured curable material structure during curing. For example, without limitation, the semi-rigid foam member 12 may be used as a concrete expansion joint or a concrete form member. Each stabilizing bracket 14 comprises a bracket body 20 having a base surface 22 and a facial surface 24 and at least one protrusion 26 extending from the facial surface 24. Each protrusion 26 is configured to be manually and toollessly inserted into the semi-rigid foam member 12 to secure the bracket body 20 of the respective stabilizing bracket 14 to the semi-rigid foam member 12. In this embodiment, the protrusion 26 is configured to be manually and toollessly inserted into the semi-rigid foam member 12 with a force of less than 50 Newtons, and more particularly with a force between 42 Newtons and 50 Newtons. When the protrusion 26 of a respective stabilizing bracket 14 is inserted into the semi-rigid foam member 12, the facial surface 24 of the bracket body 20 abuts the wall surface 18 of the semi-rigid foam member 12, and the base surface 22 of the bracket body 20 is adjacent the base surface 16 of the semi-rigid foam member 12. The bracket body 20 of each stabilizing bracket 14 can be secured to a support structure (see FIGS. 3A-3C) to secure the bracket body 20 and the semi-rigid foam member 12 to a support surface of the support structure, with the base surface 16 of the bracket body 20 and the base surface 22 of the semi-rigid foam member 12 abutting the support surface.

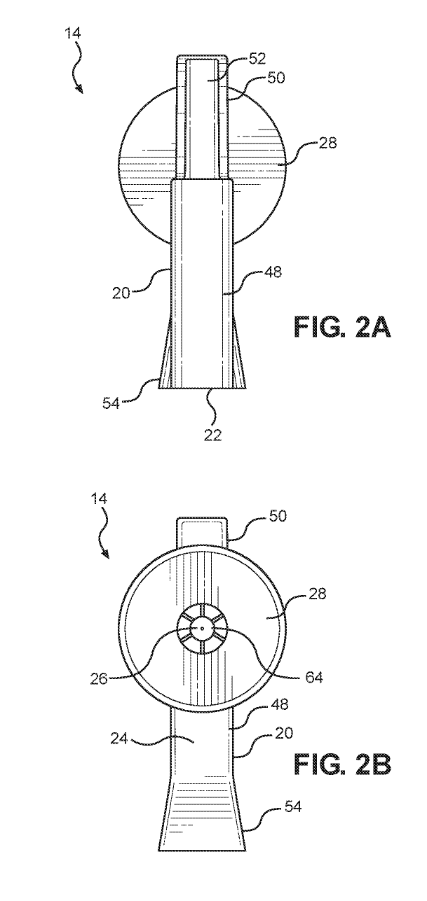

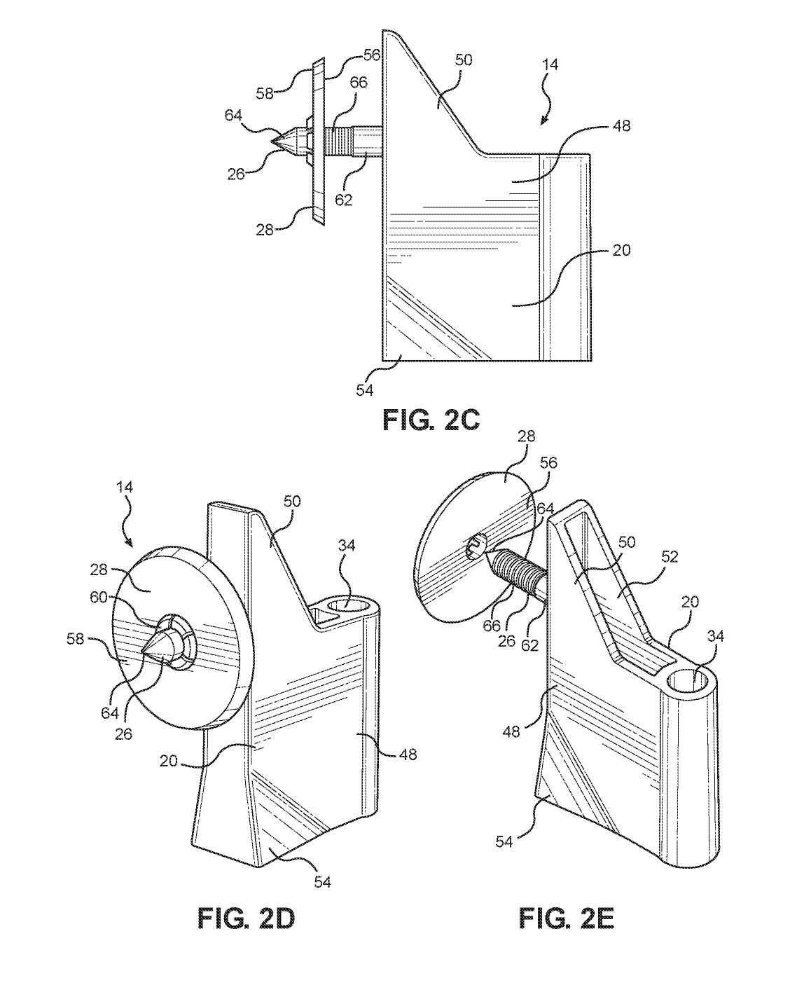

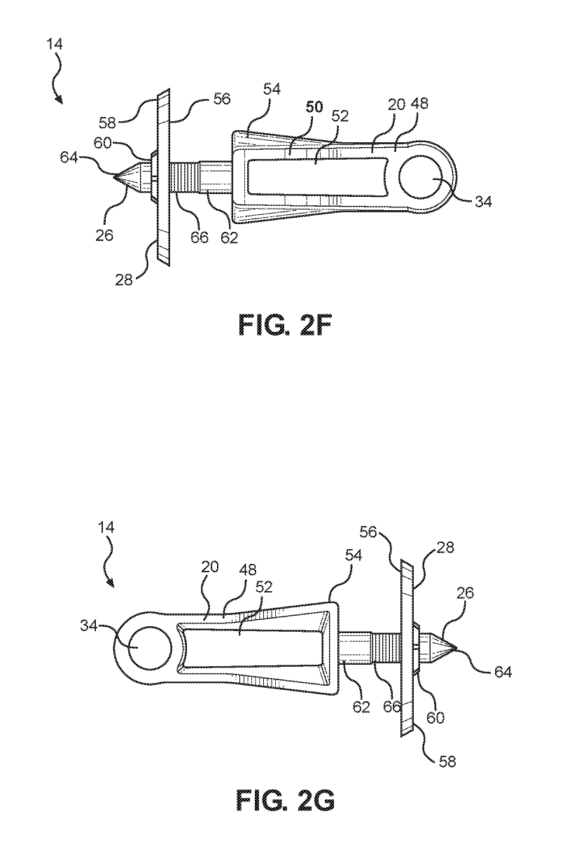

As seen in FIGS. 1A and 1B, the protrusions 26 of the stabilizing brackets 14 can be manually punctured through the semi-rigid foam member 12. A plurality of locking disks 28 (described in greater detail with respect to FIGS. 2A-2G) are secured around the protrusions 26 via holes 30 in the locking disks 28 to secure the stabilizing brackets 14 in place with respect to the semi-rigid foam member 12. Referring to FIGS. 1C and 1D, the stabilizing brackets 14 are configured to attach to a support surface, e.g., the ground or a foundation, via fasteners 32 inserted through respective vertical apertures 34, thereby securing the semi-rigid foam member 12 in place with respect to the support surface.

Before attaching the stabilizing brackets to the support surface, the semi-rigid foam member 12, with the inserted stabilizing brackets 14, is positioned so that the wall surface 18 and an opposite wall surface 36 of the semi-rigid foam member 12 are positioned vertically, and the base surface 16 and a top surface 38 of the semi-rigid foam member 12 are positioned horizontally. A pair of end surfaces 40 of the semi-rigid foam member 12 are also positioned vertically. Once the semi-rigid foam member 12 and stabilizing brackets 14 have been positioned correctly, each stabilizing bracket 14 receives the fastener 32, such as a nail or spike, though the vertical aperture 34 in the stabilizing bracket 14. In this embodiment, each fastener 32 is a nail having a straight shaft 42 with a point 44 on one end and a head 46 on the other. The point 44 is passed through the vertical aperture 34 toward the support surface, and is driven into the support surface with a hammer or other suitable device until the head 46 abuts the bracket body 20, thereby securing the stabilizing bracket 14 in place. It should be understood that other types of fasteners may be used and that, in some embodiments, the fastener 32 may be integrated with the stabilizing bracket as a single part. By securing a number of stabilizing brackets 14 along the length of the semi-rigid foam member 12 to the support surface in this manner, the semi-rigid foam member 12 is secured in place with respect to the support surface for the subsequent concrete pour.

As discussed above, each stabilizing bracket comprises a bracket body 20 and a protrusion 26. In this regard, FIGS. 2A-2G illustrate respective front, rear, side, front perspective, rear perspective, top, and bottom views of the stabilizing bracket 14 of FIGS. 1A-1D, showing additional details thereof. As shown by FIGS. 2A-2G, the bracket body 20 in this embodiment includes a generally rectangular base portion 48 and a generally triangular steeple portion 50 positioned above the base portion 48. In this embodiment, the base portion 48 and steeple portion 50 are hollow, forming an interior void 52 therein. This is because the structural strength of the stabilizing bracket 14 only needs to be sufficient to hold the relatively light semi-rigid foam member 12 in place for a relatively short period of time, i.e., before and during the concrete pour. As a result, the base portion 48 and steeple portion 50 can be made hollow to reduce the amount of material used to form the stabilizing bracket 14, thereby reducing production costs without adversely impacting the functionality of the stabilizing bracket 14.

In this embodiment, the bracket body 20 has a flared base 54 proximate to an apex of the base surface 22 and the facial surface of the stabilizing bracket 14. This flared base 54 provides additional surface area for abutting both the semi-rigid foam member 12 and support surface, which in turn reduces the possibility of the stabilizing bracket 14 twisting or tipping with respect to the semi-rigid foam member 12 or support surface during installation.

As discussed above with respect to FIGS. 1A-1D, a locking disk 28 is provided in this embodiment to attach to the protrusion 26 of the stabilizing bracket 14, to secure the semi-rigid foam member 12 therebetween. As shown in greater detail with regard to FIGS. 2A-2G, the locking disk 28 includes a first side 56 and a second side 58, with a plurality of flanges 60 arranged around an interior of the hole 30. The protrusion 26 includes a shaft 62 having a sharp point 64 that is sufficient to manually poke, or puncture, through the semi-rigid foam member 12, which is an approximate 4 lbs/ft³ density polypropylene foam expansion joint in this embodiment. The shaft 62 includes a plurality of ridges 66 configured to lockingly engage with the flanges 60 of the locking disk 28. After the protrusion 26 penetrates through the semi-rigid foam member 12 and exits the opposite wall surface 36, the protrusion is passed through the hole 30 of the locking disk 28 to that the flanges 60 of the locking disk 28 engage the ridges 66 of the shaft 62 of the protrusion 26. The facial surface 24 of the stabilizing bracket 14 is held against the wall surface 18 of the semi-rigid foam member 12 and the first side 56 of the locking disk 28 is held against the opposite wall surface 36 of the semi-rigid foam member 12, thereby securing the semi-rigid foam member 12 between the stabilizing bracket 14 and the locking disk 28.

In this manner the stabilizing brackets 14 are configured to secure the semi-rigid foam member 12 in place against the horizontal forces resulting from an adjacent concrete pour. In this regard, FIG. 3A illustrates an external form 68 comprising a plurality of rigid members 70, such as 2×4 wooden members, provided on a support surface 72 of a support structure 74, such as a ground surface or foundation. Systems 10 similar to the system 10 of FIGS. 1A-1D are disposed within the external form 68 at regular intervals. As shown in FIGS. 3B and 3C, curable material 76, which is concrete in this embodiment, is poured into the external form 68 and around the systems 10 to form a curable material structure 78, which is a sidewalk in this example. In this embodiment, the stabilizing brackets 14 are shorter in height than the semi-rigid foam member 12 so that the stabilizing brackets will become submerged under the curable material 76 after the pour. As the curable material 76 cures around the stabilizing brackets 14, the semi-rigid foam member 12 is rigidly retained between the curable material structure 78, allowing only the top of the expansion joint to be visible. In some embodiments, the semi-rigid foam member 12 may include grooves or channels (not shown) to provide a larger surface area for bonding with the curable material 76 during curing.

In this and other embodiments, the semi-rigid foam member 12 and/or stabilizing brackets 14 may comprise thermoplastic of any variety, such as polypropylene, polypropylene copolymers, polystyrene, polyethylenes, ethylene vinyl acetates (EVAs), polyolefins, including metallocene catalyzed low density polyethylene, thermoplastic olefins (TPOs), thermoplastic polyester, thermoplastic vulcanizates (TPVs), polyvinyl chlorides (PVCs), chlorinated polyethylene, styrene block copolymers, ethylene methyl acrylates (EMAs), ethylene butyl acrylates (EBAs), and derivatives thereof. The semi-rigid foam member 12 and/or stabilizing brackets 14 may also or alternatively comprise thermoset of any variety such as polyurethanes, natural and synthetic rubbers, such as latex, silicones, EPDM, isoprene, chloroprene, neoprene, melamine-formaldehyde, polyester, and derivatives thereof. The semi-rigid foam member 12 and/or stabilizing brackets 14 may also include hydrophobic materials for ease of cleaning. It should also be understood that other types of materials may be used for form the foam member 12 and/or stabilizing brackets 14 with any desired density to provide the desired strength, resiliency, and/or expansion characteristics, as desired. The semi-rigid foam member 12 may also include one or more internal holes, voids, or channels, for achieving desired mass, resiliency, minimum bend radius, and/or expansion characteristics for the semi-rigid foam member 12. Adjacent semi-rigid foam members 12 may also be joined together in series by interconnecting pins, dowels, clips, locking devices, or other fasteners (not shown), to provide expansion joints of varying lengths.

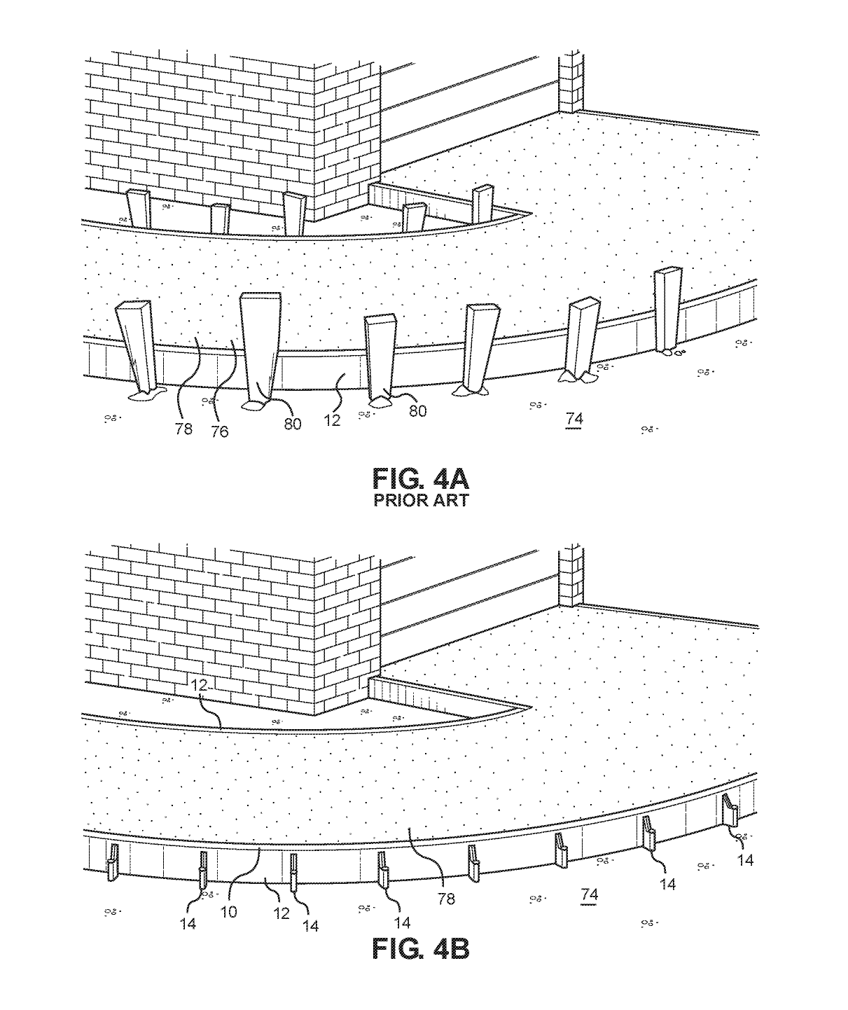

The stabilizing brackets 14 described above may be used in a number of different ways based on any number of customizable design criteria. In this regard, FIGS. 4A illustrates a conventional method of securing a support structure 74, while FIG. 4B illustrate the use of stabilizing brackets 14 to secure the support structure 74. In FIG. 4A, a curable material structure 78 is formed within a support structure 74 comprising semi-rigid foam members 12 or other member, to form a curved border as a decorative element of the curable material structure 78. The semi-rigid foam members 12 are held in place against the horizontal forces of the curable material 76 during curing by a plurality of spikes 80 driven into the support structure 74 and abutting the semi-rigid foam members 12 at regular intervals. Conventionally, the spikes 80 may be rough wooden members, and it is common for pieces of scrap wood to be used. This can result in uneven support for the curable material 76 during curing. Referring now to FIG. 4B, the stabilizing brackets 14 can be used to secure the semi-rigid foam members 12 in a variety of shapes, with more uniform and predictable results. The flexibility of the semi-rigid foam member 12 combined with the consistent support characteristics of the stabilizing brackets 14 results in a more attractive result. After the curable material 76 cures into the curable material structure 78, the stabilizing brackets 14 can also be removed for reuse, thereby producing both labor and cost savings.

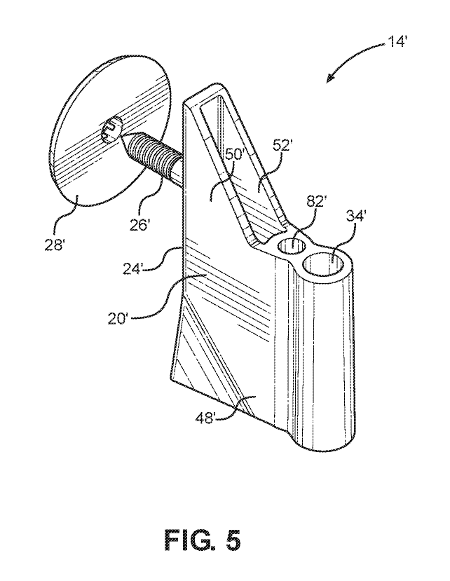

It should be understood that aspects of the stabilizing bracket 14 may be modified to provide more features and versatility. In this regard, FIG. 5 illustrates an isometric view of a stabilizing bracket 14′ according to an alternative embodiment. In this embodiment, the stabilizing bracket 14′ includes a second aperture 82′, which is differently sized than the aperture 34′. The availability of two differently sized apertures 34′, 82′ allows differently sized fasteners 32 to be used for different applications. For example, when the stabilizing bracket 14′ is positioned on an earthen foundation, a larger-diameter fastener 32, such as a spike, may be driven into the foundation through the larger aperture 34′ to secure the stabilizing bracket thereto (not shown). When the stabilizing bracket 14′ is positioned over a wooden support surface, on the other hand, a more suitable smaller-diameter fastener 32, such as a nail or screw, may be driven into the wooden support surface to secure the stabilizing bracket 14′ to the support surface.

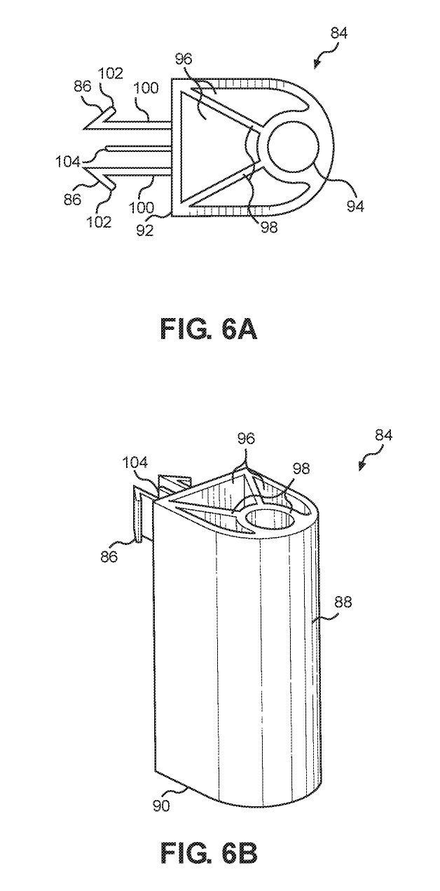

In another embodiment, top and perspective views of an alternative type of stabilizing bracket 84 having a pair of barbed protrusions 86 are illustrated by FIGS. 6A and 6B. The stabilizing bracket 84 of this embodiment comprises a bracket body 88 having a base surface 90 for engaging a support surface and a facial surface 92 for engaging a surface of an expansion joint member, such as the wall surface 18 of the semi-rigid foam member 12, for example. The stabilizing bracket 84 forms an aperture 94 for receiving a fastener, such as fastener 32 therethrough, to secure the stabilizing bracket 84 to the support surface. In this embodiment, the bracket body 88 is hollow, forming one or more interior voids 96 to reduce the amount of material used for the bracket body 88. In this embodiment, a pair of struts 98 span the interior voids 96 to add structural support for the bracket body 88 without adding an unnecessary amount of material to the stabilizing bracket 84.

Each of the pair of barbed protrusions 86 includes an extension member 100 extending substantially normal to the facial surface 92 of the stabilizing bracket 84. A barb member 102 extends back from the distal end of each extension member 100 for inhibiting removal of the stabilizing bracket 84 from the semi-rigid foam member 12. In this embodiment, a center protrusion 104 is also provided between the barbed protrusions 86 to aid in penetrating the semi-rigid foam member 12.

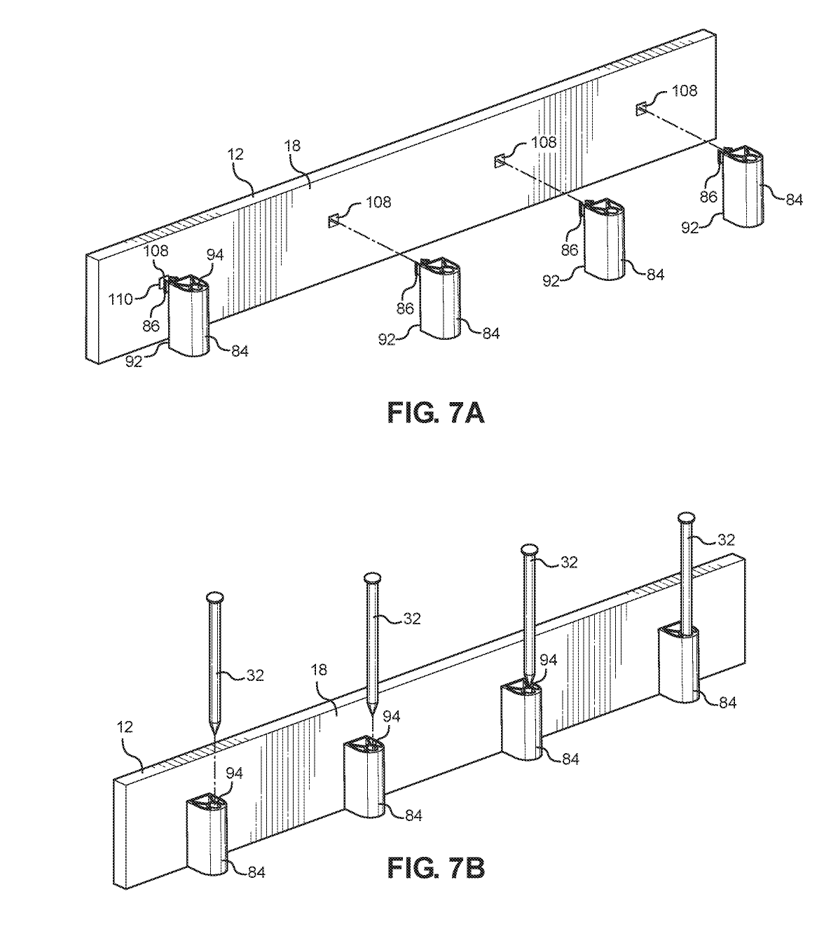

In this regard, FIGS. 7A and 7B illustrate a method of securing the semi-rigid foam member 12 using the stabilizing brackets 84 of FIGS. 6A and 6B. In this embodiment, the semi-rigid foam member 12 may include partially cut through holes 108 sized to accommodate the barbed protrusions 86. The partially cut through holes 108 may retain a cutout portion 110 therein, which may be punched out and discarded when inserting the barbed protrusions 86 through the through holes 108. The partially cut through holes 108 may be factory cut or cut in the field, as needed. The center protrusion 104 may also aid in punching out the cutout portion 110 when securing the stabilizing bracket 84 to the semi-rigid foam member 12. As shown by FIG. 7B, a plurality of fasteners 32 may then be inserted through the respective apertures 94 of the stabilizing brackets 84 and driven into the support surface.

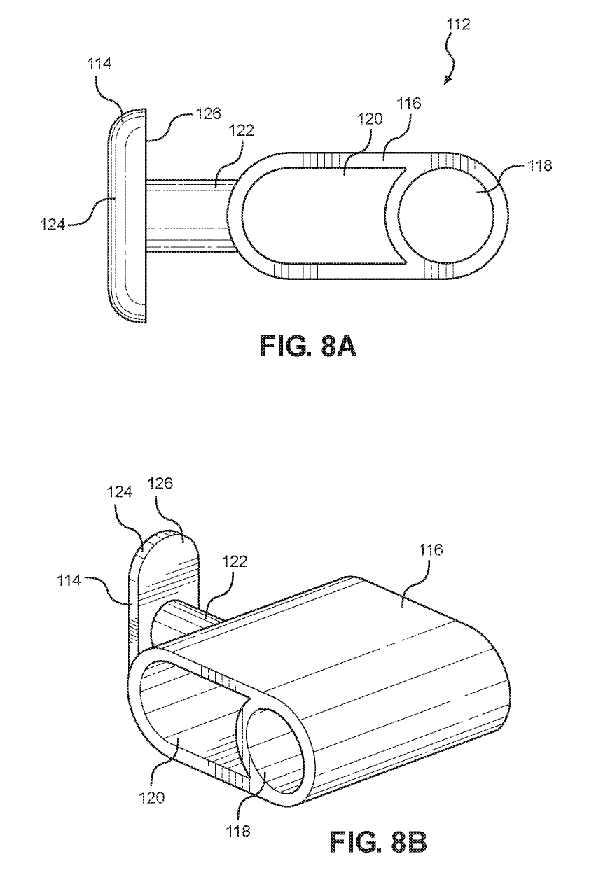

In another embodiment, FIGS. 8A and 8B illustrate top and perspective views of an alternative stabilizing bracket 112 having a keyed protrusion 114 configured to be rotated after insertion through the semi-rigid foam member 12, thereby inhibiting removal of the stabilizing bracket 112 from the semi-rigid foam member 12. The stabilizing bracket 112 includes a bracket body 116 forming an aperture 118 for a fastener 32 and an interior void 120 for reducing the amount of material used to form the stabilizing bracket 112. The keyed protrusion 114 has a shaft 122 extending from the bracket body 116 and a flat key portion 124 extending substantially normal to the shaft 122. The key portion 124 includes an interior surface 126 for engaging with the semi-rigid foam member 12 after insertion.

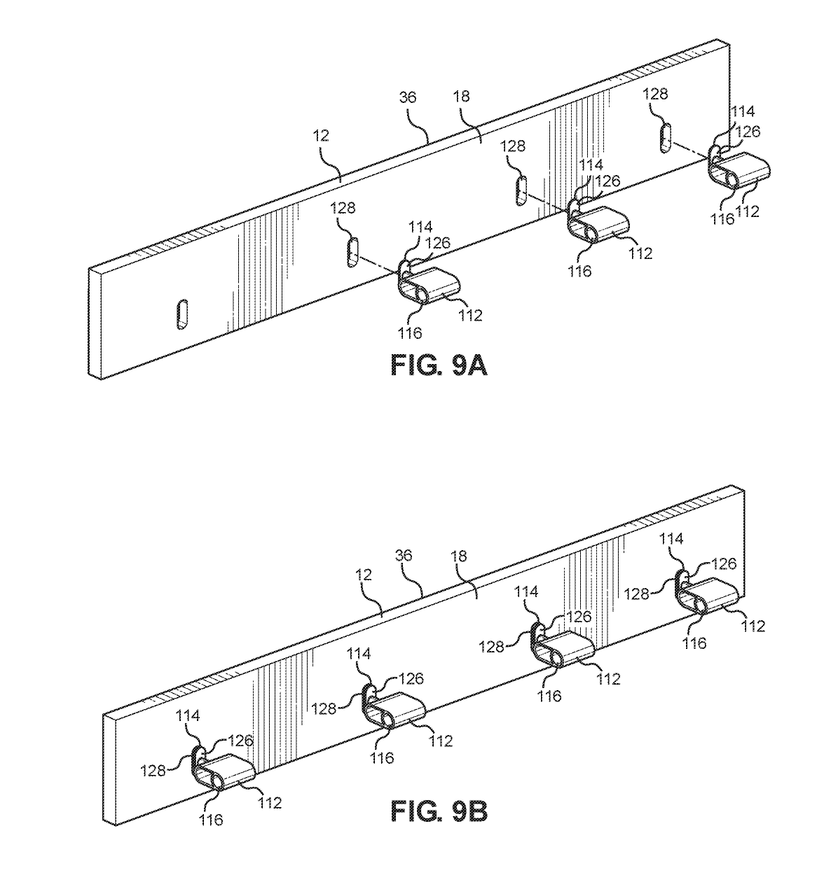

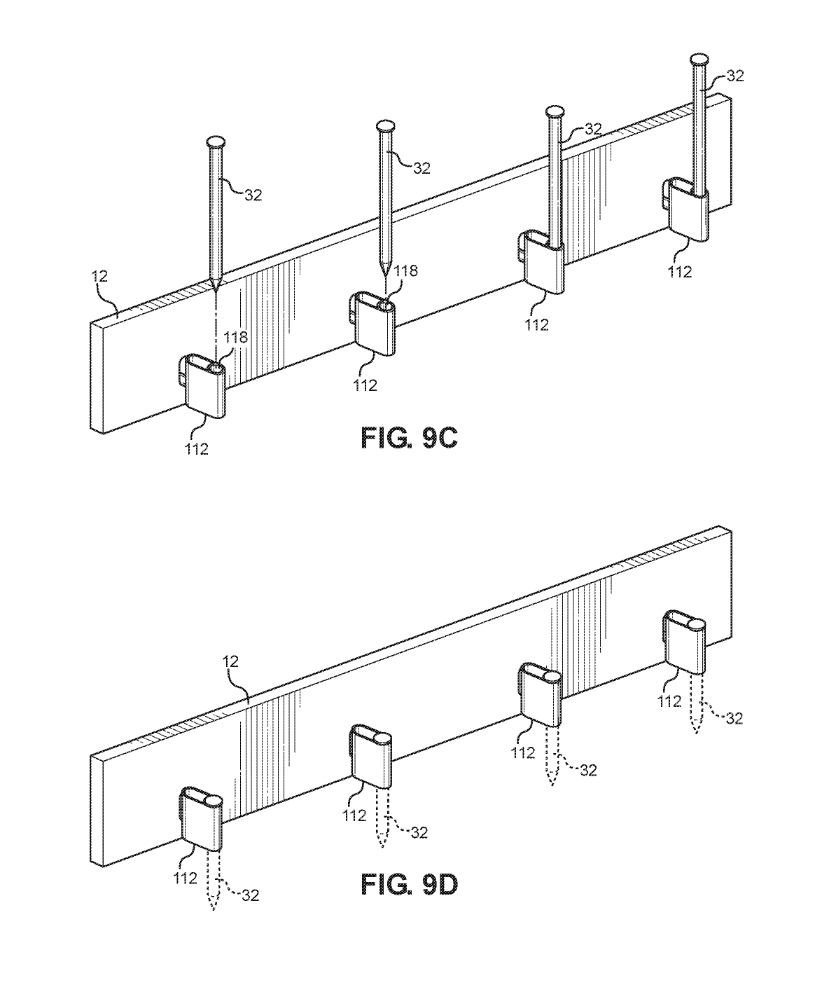

In this regard, FIGS. 9A-9D illustrate a method of securing the semi-rigid foam member 12 using the stabilizing brackets 112 of FIG. 8A and 8B, according to an embodiment. As shown in FIGS. 9A and 9B, each stabilizing bracket 112 is rotated so that the flat key portion 124 is oriented vertically in line with complementary pre-cut thru holes 128 formed in the semi-rigid foam member 12. As shown in FIG. 9C, the stabilizing brackets 112 are rotated after insertion so that the key portion is oriented horizontally, with the interior surface 126 of the key portion 124 abutting the opposite wall surface 36 of the semi-rigid foam member 12 and inhibiting removal of the stabilizing bracket 112 from the semi-rigid foam member 12. As shown in FIGS. 9C and 9D, with the apertures 118 now oriented vertically, fasteners 32 can be now be disposed vertically through the apertures 118 and driven into the underlying support structure to secure the semi-rigid foam member 12 with respect to the support structure.

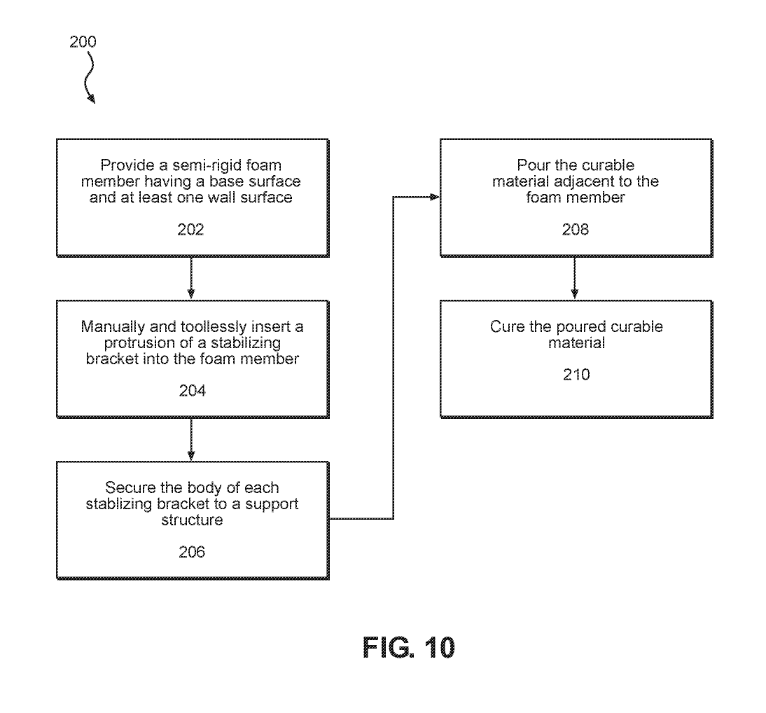

Referring now to FIG. 10, a method 200 of securing a semi-rigid foam member, such as semi-rigid foam member 12, with respect to a poured curable material structure is disclosed. The method 200 comprises providing a semi-rigid foam member having a base surface and at least one wall surface (Block 202). The method 200 further comprises manually and toollessly inserting a protrusion of at least one stabilizing bracket, such as the stabilizing bracket 14, into the semi-rigid foam member to secure a body of the stabilizing bracket to the semi-rigid foam member (Block 204). A facial surface of the body abuts the wall surface, and the base surface of the body is adjacent the base surface of the semi-rigid foam member. The method further comprises securing the body of each stabilizing bracket to a support structure to secure the body and the semi-rigid foam member to a support surface of the support structure (Block 206). The base surface of the body and the base surface of the semi-rigid foam member abut the support surface, and the wall surface of the semi-rigid foam member is configured to be disposed adjacent a poured curable material structure during curing. The method 200 may also include pouring the curable material adjacent the semi-rigid foam member such that the at least one stabilizing bracket is submerged in the poured curable material (Block 208), and curing the poured curable material such that the at least one stabilizing bracket is permanently enclosed within the poured curable material (Block 210).

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It will be apparent to those skilled in the art that various modifications and variations can be made without departing from the spirit or scope of the invention. Since modifications combinations, sub-combinations and variations of the disclosed embodiments incorporating the spirit and substance of the invention may occur to persons skilled in the art, the invention should be construed to include everything within the scope of the appended claims and their equivalents.

What is claimed is:

1. A system for securing a semi-rigid foam member with respect to a poured curable material structure, the system comprising:
a semi-rigid foam member having a base surface and at least one wall surface;
at least one stabilizing bracket, each stabilizing bracket comprising:
a body comprising a base surface and a facial surface; and
at least one protrusion extending from the facial surface, the at least one protrusion configured to be manually and toollessly inserted into the semi-rigid foam member to secure the body to the semi-rigid foam member, with the facial surface of the body abutting one of the at least one wall surface, and with one of the at least one wall surface of the semi-rigid foam member and the base surface of the body adjacent the base surface of the semi-rigid foam member; and
the body of each stabilizing bracket configured to be secured to a support structure to secure the body and the semi-rigid foam member to a support surface of the support structure, such that the base surface of the body and the base surface of the semi-rigid foam member abut the support surface, and such that the at least one wall surface of the semi-rigid foam member is configured to be disposed adjacent a poured curable material structure during curing.

2. The system of claim 1, wherein the semi-rigid foam member is an expansion joint configured to expand and contract in response to an expansion and contraction of the poured curable material structure.

3. The system of claim 1, wherein the semi-rigid foam member is a form member configured to retain the poured curable material structure when the poured curable material structure is disposed adjacent the at least one wall surface of the semi-rigid foam member during curing.

4. The system of claim 1, wherein the semi-rigid foam member has a minimum bend radius.

5. The system of claim 1, wherein the poured curable material structure comprises poured concrete.

6. The system of claim 1, wherein the at least one protrusion is configured to be manually and toollessly inserted into the semi-rigid foam member with a force of less than 50 Newtons.

7. The system of claim 1, wherein the at least one protrusion is configured to be manually and toollessly inserted into the semi-rigid foam member with a force between 42 Newtons and 50 Newtons.

8. The system of claim 1, wherein the body further comprises at least one opening configured to receive at least one fastener therethrough, the body configured to be secured to the support structure by the at least one fastener.

9. The system of claim 8, wherein the at least one opening is a plurality of openings, each configured to receive at least one fastener therethrough, the body configured to be secured to the support structure by the at least one fastener.

10. The system of claim 9, wherein the plurality of openings comprises a first opening configured to receive a spike therethrough to secure the body to the support structure, and a second opening configured to receive a nail therethrough to secure the body to the support structure.

11. The system of claim 8, wherein the at least one fastener comprises a spike.

12. The system of claim 8, wherein the at least one fastener comprises a nail.

13. The system of claim 1, wherein the at least one protrusion comprises at least one spike configured to be inserted into the semi-rigid member by puncturing the semi-rigid foam member.

14. The system of claim 13, wherein the protrusion of the stabilizing bracket is unitary with the body of the stabilizing bracket.

15. The system of claim 1, wherein the support structure is an earthen structure.

16. A stabilizing bracket for securing a semi-rigid foam member with respect to a poured curable material structure, the stabilizing bracket comprising:
a body comprising a base surface and a facial surface;
at least one protrusion extending from the facial surface, the at least one protrusion configured to be manually and toollessly inserted into a semi-rigid foam member to secure the body to the semi-rigid foam member, with the facial surface of the body abutting one of at least one wall surface, and with one of the at least one wall surface of the semi-rigid foam member and the base surface of the body adjacent the base surface of the semi-rigid foam member; and
the body of each stabilizing bracket configured to be secured to a support structure to secure the body and the semi-rigid foam member to a support surface of the support structure, such that the base surface of the body and the base surface of the semi-rigid foam member abut the support surface, and such that the at least one wall surface of the semi-rigid foam member is configured to be disposed adjacent a poured curable material structure during curing.

17. The stabilizing bracket of claim 16, wherein the body further comprises at least one opening configured to receive at least one fastener therethrough, the body configured to be secured to the support structure by the at least one fastener.

18. The stabilizing bracket of claim 16, wherein the at least one protrusion comprises at least one spike configured to be inserted into the semi-rigid member by puncturing the semi-rigid member.

19. A method of securing a semi-rigid foam member with respect to a poured curable material structure, the method comprising:
providing a semi-rigid foam member having a base surface and at least one wall surface;
manually and toollessly inserting a protrusion of at least one stabilizing bracket into the semi-rigid foam member to secure a body of the stabilizing bracket to the semi-rigid foam member, with a facial surface of the body abutting one of the at least one wall surface, and with one of the at least one wall surface of the semi-rigid foam member and the base surface of the body adjacent the base surface of the semi-rigid foam member; and
securing the body of each stabilizing bracket to a support structure to secure the body and the semi-rigid foam member to a support surface of the support structure, such that the base surface of the body and the base surface of the semi-rigid foam member abut the support surface, and such that the at least one wall surface of the semi-rigid foam member is configured to be disposed adjacent a poured curable material structure during curing.

20. The method of claim 19, further comprising:
pouring poured curable material adjacent the semi-rigid foam member such that the at least one stabilizing bracket is submerged in the poured curable material; and
curing the poured curable material to form the poured curable material structure such that the at least one stabilizing bracket is permanently enclosed within the poured curable material.
